(19) United States
(12) Patent Application Publication
(10) Pub. No.: US 2011/0287297 A1
(43) Pub. Date: Nov. 24, 2011

(54) NONAQUEOUS ELECTROLYTE SECONDARY BATTERY

(76) Inventors: Toshitada Sato, Osaka (JP); Kozo Watanabe, Osaka (JP)

(21) Appl. No.: 13/147,520

(22) PCT Filed: Oct. 29, 2010
(86) PCT No.: PCT/JP2010/006405

§ 371 Date: Aug. 2, 2011

(30) Foreign Application Priority Data
Dec. 11, 2009 (JP) 2009-281856

(51) Int. Cl. H01M 10/05; H01M 2/16

(52) U.S. Cl. 429/145

(57) ABSTRACT

A separator (6) is disposed between a positive electrode (4) and a negative electrode (5), and includes a main body layer (6A) and a plurality of thin films (6B), (6C). Each of the plurality of thin films (6B), (6C) has a smaller thickness than the main body layer (6A), and a lower ionic permeability ratio than the main body layer (6A). Moreover, the plurality of thin films (6B), (6C) have ionic permeability ratios different from each other.

### TECHNICAL FIELD

The present invention relates to nonaqueous electrolyte secondary batteries.

### BACKGROUND ART

In recent years, there have been demands for use of electric energy to drive vehicles in view of environmental protection, and also demands for use of DC power sources for, for example, large-size tools. To satisfy such demands, small-size and lightweight secondary batteries which can be charged quickly and can discharge a high current are required. Typical examples of secondary batteries satisfying such demands include a nonaqueous electrolyte secondary battery (hereinafter also simply referred to as a “battery”).

A nonaqueous electrolyte secondary battery includes a positive electrode, a negative electrode, and a separator. In the positive electrode, a material which electrochemically reacts reversibly with lithium ions (a positive electrode active material, a lithium-containing composite oxide) is held by a positive electrode current collector (see Patent Document 1). In the negative electrode, a material capable of inserting and extracting lithium (a negative electrode active material, e.g., graphite or a tin alloy) is held by a negative electrode current collector (see Patent Document 2). The separator is interposed between the positive electrode and the negative electrode. The separator prevents short-circuiting between the positive electrode and the negative electrode, and holds an electrolyte. The electrolyte is an aprotic organic solvent in which lithium salt (e.g., LiClO₄ or LiPF₆) is dissolved.

The nonaqueous electrolyte secondary battery is fabricated according to the following method. First, the positive electrode and the negative electrode are each formed into a thin film sheet, or foil, and the positive electrode and the negative electrode are stacked or wound in a spiral with the separator interposed therebetween. The thus obtained electrode group is placed in a battery case (which may be made of metal such as ion, aluminum, stainless steel, or the like, or may be a case with a surface plated with nickel, or the like), and the nonaqueous electrolyte is injected in the battery case. Thereafter, an opening of the battery case is sealed with a lid. Instead of the battery case made of metal, an aluminum laminate film may be used.

### Citation List

### Patent Document

Patent Document 1: Japanese Patent Publication No. H11-7958

Patent Document 2: Japanese Patent Publication No. H11-242954

### SUMMARY OF THE INVENTION

### Technical Problem

During the process of fabricating the nonaqueous electrolyte secondary battery, foreign particles made of metal (hereinafter referred to as “metallic foreign particles”) may enter the nonaqueous electrolyte secondary battery. Typical examples of the metallic foreign particles are metal entering the positive electrode active material or a conductive agent during synthesis thereof, or metal chips produced due to wear of rotating parts such as bearings, rollers, or the like of a device for the fabrication during the process of fabricating the nonaqueous electrolyte secondary battery. Thus, examples of materials for the metallic foreign particles include iron, nickel, copper, stainless steel, and brass. These metallic foreign particles dissolve in nonaqueous electrolyte at an operating potential of the positive electrode, and become ions, which are deposited as metal on a surface of the negative electrode, for example, during charging. When the metallic foreign particles deposited on the surface of the negative electrode penetrate through the separator, and reach the positive electrode, an internal short-circuit occurs.

In view of the foregoing, it is an objective of the present invention to provide a nonaqueous electrolyte secondary battery with its safety being ensured.

### Solution to the Problem

In a nonaqueous electrolyte secondary battery of the present invention, a positive electrode, a negative electrode, a separator, and a nonaqueous electrolyte are placed in a battery case. The separator includes a main body layer and a plurality of thin films. Each of the thin films has a smaller thickness than the main body layer, and a lower ionic permeability ratio than the main body layer. The thin films have ionic permeability ratios different from each other. In such a nonaqueous electrolyte secondary battery, it is possible to reduce the penetration of metallic foreign particle ions into the thin films in the thickness direction. Thus, the metallic foreign particle ions can be prevented from arriving at a surface of the negative electrode.

In the nonaqueous electrolyte secondary battery of the present invention, a thin film which is the lowest in ionic permeability ratio among the plurality of thin films is preferably provided on the surface of the negative electrode. The thin film which is the lowest in ionic permeability ratio among the plurality of thin films is more preferably adhered to the surface of the negative electrode. With this configuration, it is possible to reduce the arrival of the metallic foreign particle ions at the surface of the negative electrode.

In the nonaqueous electrolyte secondary battery of the present invention, the plurality of thin films are preferably arranged such that the ionic permeability ratio of the thin films decreases from the positive electrode toward the negative electrode. With this configuration, the amount of metallic foreign particle ions penetrating the electrode group in the thickness direction can gradually be reduced from the positive electrode toward the negative electrode. In such a nonaqueous electrolyte secondary battery, a thin film which is the highest in ionic permeability ratio among the plurality of thin films may be integrated into the main body layer.

In a preferred embodiment described below, the plurality of thin films have hexafluoropropylene concentrations different from each other, the thin film having a high hexafluoropropylene concentration has a higher ionic permeability ratio than the thin film having a low hexafluoropropylene concentration. In this case, each of the thin films may contain a copolymer of hexafluoropropylene and vinylidene fluoride, and a thin film which is the lowest in ionic permeability ratio among the plurality of thin films may be made of polyvinylidene fluoride.

In the nonaqueous electrolyte secondary battery of the present invention, the positive electrode may include composite oxide containing lithium, first metal (which is metal except for the lithium), and oxygen, and x/y is preferably greater than 1.05, where the total number of moles of lithium contained in the positive electrode and the negative electrode is x[mol], and the total number of moles of the first metal in the composite oxide is y[mol]. With this configuration, an internal short-circuit caused by the entry of metallic foreign particles can be reduced even when the irreversible capacity is large (the capacity at the first discharge is smaller than the capacity at the first charge). The advantages increase when the negative electrode contains silicon, tin, or a compound containing silicon or tin.

The “plurality of thin films” in this specification includes the case where an interface between the thin films cannot be recognized. For example, when thin films each having a very small thickness are stacked, it may be difficult to recognize the interface between the thin films.

In this specification, the “ionic permeability ratio” can be measured according to, for example, the following method. First, an electrolyte (A) containing metal salt is disposed on one side of a predetermined film (a film whose ionic permeability ratio is to be measured), and a solution (B) containing no metal salt is disposed on the other side of the predetermined film. After the elapse of a predetermined time, the salt concentration of the solution (B) is measured. Alternatively, after the elapse of a predetermined time, the ionic conductivity of the solution (B) is measured, and the salt concentration of the solution (B) is estimated using a calibration curve shows the relation ship between the salt concentration and the ionic conductivity, the calibration curve being created in advance.

In this specification, “ions” of the “ionic permeability ratio” are cations in the nonaqueous electrolyte, and include lithium ions in addition to metallic foreign particle ions.

In this specification, the “thin film is integrated into the main body layer” means that the interface between the thin film and the main body layer cannot clearly be recognized, and for example, part of a material forming the thin film penetrates into the main body layer. When both the main body layer and the thin film are made of a resin, the thin film may be integrated into the main body layer.

In this specification, the “surface of the positive electrode” is one of both surfaces of the positive electrode which faces the negative electrode inserting and extracting lithium ions into and from the positive electrode, and the “surface of the negative electrode” is one of both surfaces of the negative electrode which faces the positive electrode inserting and extracting lithium ions into and from the negative electrode.

### Advantages of the Invention

The present invention can provide a nonaqueous electrolyte secondary battery with its safety being ensured.

### BRIEF DESCRIPTION OF THE DRAWINGS

FIGS. 1A-1C are cross-sectional views illustrating deposition of metallic foreign particles on a surface of the negative electrode.

FIG. 2 is a longitudinal cross-sectional view illustrating a nonaqueous electrolyte secondary battery of an embodiment of the present invention.

FIG. 3 is a cross-sectional view illustrating an electrode group of the embodiment of the present invention.

FIG. 4 is a cross-sectional view illustrating migration of metallic foreign particle ions in a separator of the embodiment of the present invention.

FIG. 5 is a table showing results of a first example.

FIG. 6 is a table showing results of a second example.

FIG. 7 is a table showing results of a third example.

### DESCRIPTION OF EMBODIMENTS

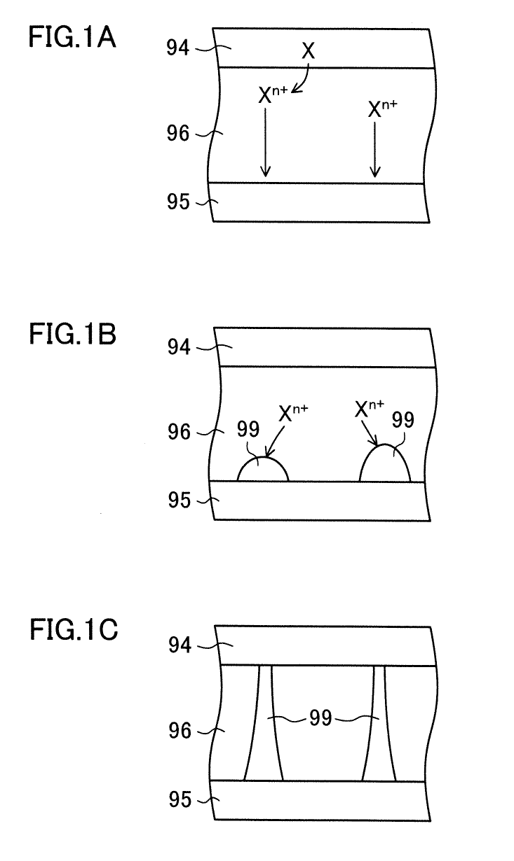

The inventors of the present invention have studied deposition of metallic foreign particles on a surface of a negative electrode, and have produced the following finding. FIGS. 1A-1C are cross-sectional views illustrating deposition of metallic foreign particles on a surface of a negative electrode. Note that, in FIGS. 1A-1C, for the sake of description, a separator 96 is illustrated with its thickness enlarged compared to the thickness of each of a positive electrode 94 and a negative electrode 95. The relationship among the thicknesses of the positive electrode 94, the negative electrode 95, and the separator 96 of FIGS. 1A-1C is different from that among the thicknesses of a positive electrode, a negative electrode, and a separator of an actual nonaqueous electrolyte secondary battery.

Metallic foreign particles (X) in the positive electrode 94 (in particular, a positive electrode active material), that is, metallic foreign particles produced during the process of fabricating a nonaqueous electrolyte secondary battery, or wear-induced metallic foreign particles dissolve at an immersion potential of the positive electrode, where the immersion potential is a potential generated by wetting the positive electrode with an electrolyte, or at an operating potential of the positive electrode, and become ions (Xⁿ⁺), which migrate in the separator 96 toward a surface of the negative electrode 95, for example, during charging. Here, when the potential of the negative electrode 95 is equal to or lower than the deposition potential of the metallic foreign particles, metallic foreign particle ions are deposited on the surface of the negative electrode 95 located at a shortest distance as illustrated in FIG. 1A.

After metallic foreign particles 99 are deposited on the surface of the negative electrode 95, new metallic foreign particle ions are preferentially deposited on surfaces of the metallic foreign particles 99 as illustrated in FIG. 1B. Thus, tips of the metallic foreign particles 99 come closer to the positive electrode 94, and eventually come into contact with a surface of the positive electrode 94 as illustrated in FIG. 1C. An internal short-circuit is thus formed.

In view of the foregoing, the present inventors accomplished the present invention. Embodiments of the present invention will be described below with reference to the drawings. The present invention is not limited to the following embodiments. In the following description, the same components may be indicated by the same reference characters.

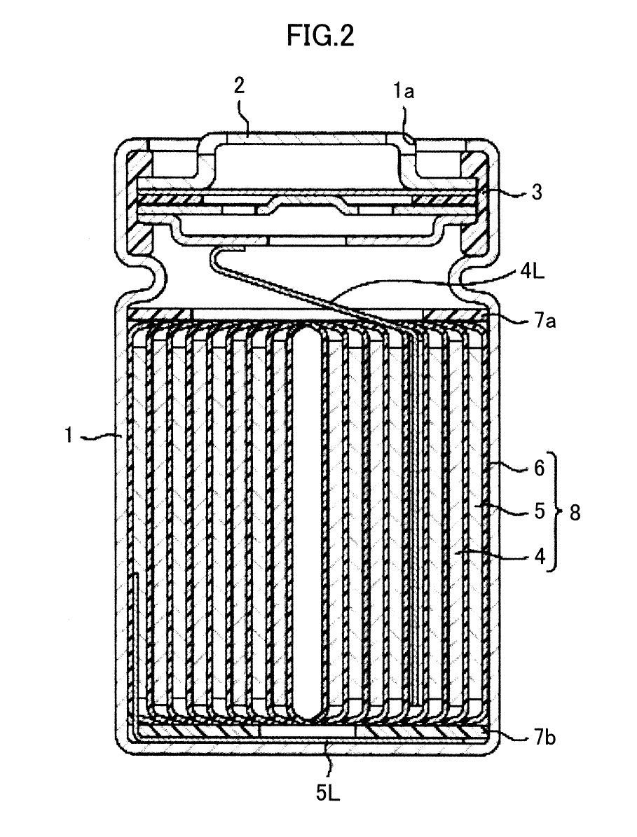

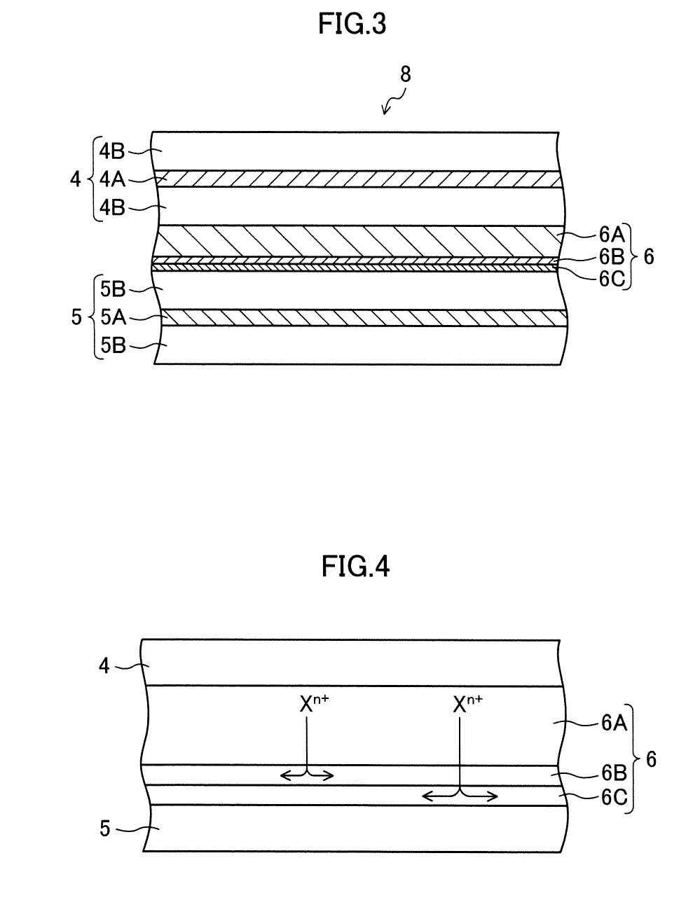

In the embodiments of the present invention, a lithium ion secondary battery is taken as a specific example of a nonaqueous electrolyte secondary battery, and the configuration thereof will be described. FIG. 2 is a longitudinal cross-sectional view illustrating the nonaqueous electrolyte secondary battery of the present embodiment. FIG. 3 is a cross-sectional view illustrating an electrode group of the present embodiment.

As illustrated in FIG. 2, the nonaqueous electrolyte secondary battery of the present embodiment includes, a battery case 1 made of, for example, stainless steel, and an electrode group 8 placed in the battery case 1. A nonaqueous electrolyte is injected in the battery case 1.

An upper surface of the battery case 1 has an opening 1a. A sealing plate 2 is crimped onto the opening 1a via a gasket 3, thereby sealing the opening la.

The electrode group 8 includes a positive electrode 4, a negative electrode 5, and a separator 6, where the positive electrode 4 and the negative electrode 5 are wound in a spiral with the separator 6 interposed therebetween as illustrated in FIG. 3. An upper insulating plate 7a is disposed above the electrode group 8, and a lower insulating plate 7b is disposed under the electrode group 8.

One end of a positive electrode lead 4L made of aluminum is attached to the positive electrode 4, and the other end of the positive electrode lead 4L is connected to the sealing plate 2 (also serving as a positive electrode terminal). One end of a negative electrode lead 5L made of nickel is attached to the negative electrode 5, and the other end of the negative electrode lead 5L is connected to the battery case 1 (also serving as a negative electrode terminal).

As illustrated in FIG. 3, the positive electrode 4 includes a positive electrode current collector 4A and positive electrode mixture layers 4B. The positive electrode current collector 4A is a conductive plate-like member, and is made of, for example, aluminum. The positive electrode mixture layers 4B are respectively provided on surfaces of the positive electrode current collector 4A, and contain a positive electrode active material (composite oxide containing lithium, metal except for the lithium (first metal), and oxygen; e.g., LiCoO₂), a binder, a conductive agent, and the like.

As illustrated in FIG. 3, the negative electrode 5 includes a negative electrode current collector 5A and negative electrode active material layers 5B. The negative electrode current collector 5A is a conductive plate-like member, and is made of, for example, copper. The negative electrode active material layers 5B are respectively provided on surfaces of the negative electrode current collector 5A, and may contain a graphite material and a binder, or may be made of silicon, tin, a silicon-containing compound, or a tin-containing compound (hereinafter referred to as “metal or metal-containing compound”).

The separator 6 holds the nonaqueous electrolyte, and is provided between the positive electrode 4 and the negative electrode 5 as illustrated in FIG. 3. Moreover, the separator 6 includes a main body layer 6A, a first thin film 6B, and a second thin film 6C. The main body layer 6A is provided on a surface of the positive electrode 4. The main body layer 6A has a high ionic permeability ratio, a predetermined mechanical strength, and insulating properties, and is, for example, a microporous film made of a polyolefin such as polypropylene or polyethylene, woven fabric, or nonwoven fabric. The second thin film 6C is provided on a surface of the negative electrode 5, and is preferably adhered to the surface of the negative electrode 5. The first thin film 6B is sandwiched between the main body layer 6A and the second thin film 6C, is preferably integrated into the main body layer 6A, and is preferably adhered to the second thin film 6C.

The electrode group 8 including the separator 6 as described above is formed by any of the following methods. A first method includes forming the second thin film 6C and the first thin film 6B sequentially on the surface of the negative electrode 5, bringing the main body layer 6A formed on the surface of the positive electrode 4 into contact with the first thin film 6B, and then winding these members. A second method includes forming the main body layer 6A, the first thin film 6B, and the second thin film 6C sequentially on the surface of the positive electrode 4, bringing the second thin film 6C into contact with the surface of the negative electrode 5, and then winding these members. A third method includes forming the first thin film 6B and the second thin film 6C sequentially on a surface of a carrier, where the surface of the carrier has undergone release treatment, disposing the carrier provided with the first thin film 6B and the second thin film 6C between the main body layer 6A on the surface of the positive electrode 4 and the negative electrode 5, peeling the carrier from the first thin film 6B, sandwiching the first thin film 6B and the second thin film 6C between the main body layer 6A and the negative electrode 5, and then, winding these members.

The separator 6 of the present embodiment will further be described. The main body layer 6A has a larger thickness than each of the first thin film 6B and the second thin film 6C. The thickness of the main body layer 6A is, for example, 10 μm to 300 μm, both inclusive, preferably 10 μm to 40 μm, both inclusive, more preferably 15 μm to 30 μm, both inclusive, most preferably 15 μm to 25 μm, both inclusive. The total thickness of the first thin film 6B and the second thin film 6C is, for example, 0.01 μm to 20 μm, both inclusive, preferably 0.1 μm to 15 μm, both inclusive, more preferably 0.5 μm to 10 μm, both inclusive.

When the thickness of the main body layer 6A is less than 10 μm, it may not be possible to hold a sufficient amount of the nonaqueous electrolyte. Moreover, it may not be possible to avoid contact between the positive electrode 4 and the negative electrode 5, so that an internal short-circuit may be formed. By contrast, when the thickness of the main body layer 6A is greater than 300 μm, the occupancy of the separator 6 in the electrode group 8 is high, so that a sufficient amount of the active material may not be filled in the battery case 1.

When the total thickness of the first thin film 6B and the second thin film 6C is less than 0.01 μm, it may not be possible to prevent an internal short-circuit caused by the entry of metallic foreign particles. By contrast, when the total thickness of the first thin film 6B and the second thin film 6C is greater than 20 μm, the occupancy of the first thin film 6B and the second thin film 6C in the separator 6 is high, which may deteriorate the separator 6. Moreover, the diffusion of lithium ions in the separator 6 may be reduced, which may degrade the performance of the battery.

In other words, the total thickness of the first thin film 6B and the second thin film 6C may be greater than or equal to 0.1%, preferably 0.1% to 20%, both inclusive, more preferably 0.1% to 10%, both inclusive, of the thickness of the main body layer 6A. When the total thickness of the first thin film 6B and the second thin film 6C is less than 0.1% of the thickness of the main body layer 6A, it may not be possible to prevent an internal short-circuit caused by the entry of metallic foreign particles. By contrast, when the total thickness of the first thin film 6B and the second thin film 6C is greater than 20% of the thickness of the main body layer 6A, the separator 6 may deteriorate. Moreover, the diffusion of lithium ions in the separator 6 may be reduced, which may degrade the performance of the battery.

Furthermore, the main body layer 6A, the first thin film 6B, and the second thin film 6C of the separator 6 in the present embodiment are different from one another in ionic permeability ratio. The ionic permeability ratio of the main body layer 6A is the highest, and the ionic permeability ratios of the main body layer 6A, the first thin film 6B, and the second thin film 6C decrease in the order mentioned. Thus, it is possible to prevent an internal short-circuit caused by the entry of metallic foreign particles. The separator 6 of the present embodiment will further be described below with reference to FIG. 4. FIG. 4 is a cross-sectional view illustrating the migration of metallic foreign particle ions in the separator 6 of the present embodiment. Note that in FIG. 4, for the sake of description, the separator 6 is illustrated with its thickness enlarged compared to the thickness of each of the positive electrode 4 and the negative electrode 5. The relationship among the thicknesses of the positive electrode 4, the negative electrode 5, and the separator 6 of FIG. 4 is different from that among the actual thicknesses of the positive electrode 4, the negative electrode 5, and the separator 6.

When attention is turned to metallic foreign particles entered the positive electrode mixture layer 4B, the metallic foreign particles dissolve in the nonaqueous electrolyte at an immersion potential of the positive electrode 4 or at an operating potential of the positive electrode 4, and become metal ions, which migrate toward the negative electrode 5, for example, during charging. In the separator 6, the main body layer 6A, the first thin film 6B, and the second thin film 6C are disposed in this order from the positive electrode 4 toward the negative electrode 5. Thus, the metallic foreign particle ions penetrate into the main body layer 6A, and arrive at the first thin film 6B. Since the first thin film 6B has a lower ionic permeability ratio than the main body layer 6A, some of the metallic foreign particle ions arrived at the first thin film 6B cannot penetrate through the first thin film 6B, and are diffused in the first thin film 6B (metallic foreign particle ions on the left in FIG. 4).

The metallic foreign particle ions penetrated through the first thin film 6B arrives at the second thin film 6C. Since the second thin film 6C has a lower ionic permeability ratio than the first thin film 6B, it is difficult for the metallic foreign particle ions arrived at the second thin film 6C to penetrate through the second thin film 6C, and thus the metallic foreign particle ions are diffused in the second thin film 6C (metallic foreign particle ions on the right in FIG. 4). In this way, it is possible to delay the arrival of the metallic foreign particle ions at the surface of the negative electrode 5.

Metallic foreign particles produced during the process of fabricating the nonaqueous electrolyte secondary battery or wear-induced metallic foreign particles do not necessarily enter the positive electrode 4, but may enter, for example, the main body layer 6A. Metallic foreign particle ions are diffused in the first thin film 6B or the second thin film 6C irrespective of locations of the entry of the metallic foreign particles. Thus, in the present embodiment, an internal short-circuit can be prevented irrespective of generation factors of the metallic foreign particles.

Even if metallic foreign particle ions penetrated into the second thin film 6C arrive at the surface of the negative electrode 5, the amount of the metallic foreign particle ions arriving at the surface of the negative electrode 5 can be reduced. Thus, the amount of metallic foreign particles deposited on the surface of the negative electrode 5 can be reduced. In addition, the metallic foreign particle ions penetrated through the main body layer 6A are slightly diffused in the first thin film 6B and the second thin film 6C, and then arrive at the surface of the negative electrode 5. Thus, it is possible to prevent the metallic foreign particles from being deposited in a direction perpendicular to the surface of the negative electrode 5. Therefore, in the present embodiment, an internal short-circuit can be prevented even when the metallic foreign particles are deposited on the surface of the negative electrode 5. Note that lithium ions responsible for operation of the battery exist in the nonaqueous electrolyte at a much larger amount than the metallic foreign particle ions, and thus are less susceptible to the influence of a diffusion reduction using the first thin film 6B and the second thin film 6C, and to the influence of delayed arrival at the negative electrode 5. The present inventors confirmed that the nonaqueous electrolyte secondary battery of the present embodiment has no problem in terms of operation as a battery. The configurations respectively of the first thin film 6B and the second thin film 6C will further be described.

The first thin film 6B and the second thin film 6C are different from each other in ionic permeability ratio. Moreover, the first thin film 6B is preferably adhered to surfaces of the main body layer 6A and the second thin film 6C, and the second thin film 6C is preferably adhered to the surface of the negative electrode 5. Thus, the first thin film 6B may contain a material capable of adjusting the ionic permeability ratio and a material having adhesiveness. The second thin film 6C may contain a material capable of adjusting the ionic permeability ratio and a material having adhesiveness, or may be made of a material having adhesiveness.

Examples of the material capable of adjusting the ionic permeability ratio include hexafluoropropylene (hereinafter referred to as “HFP”). Since HFP is more flexible than poly(vinylidene fluoride) (hereinafter referred to as “PVDF”) or the like, HFP absorbs an electrolyte and swells. Thus, HFP has a superior affinity for a nonaqueous electrolyte, and thus increasing the concentration of HFP in a film can increase the ionic permeability ratio of the film. Thus, the concentration of HFP may be higher in the first thin film 6B than in the second thin film 6C. For example, the concentration of HFP in the first thin film 6B is 2 percent by mass (mass %) to 30 mass %, both inclusive, and the concentration of HFP in the second thin film 6C is 0 mass % to 20 mass %, both inclusive. When the concentration of HFP in the first thin film 6B is less than 2 mass %, or when the concentration of HFP in the second thin film 6C is greater than 20 mass %, it is difficult to provide a difference between the ionic permeability ratios of the first thin film 6B and the second thin film 6C. By contrast, when the concentration of HFP in the first thin film 6B is greater than 30 mass %, the first thin film 6B easily swell in the nonaqueous electrolyte, which reduces the adhesive strength of the first thin film 6B to the main body layer 6A and to the second thin film 6C.

As materials having adhesiveness, for example, PVDF, polytetrafluoroethylene, an aramid resin, polyamide, and polyimide are known, and the first thin film 6B and the second thin film 6C preferably contain PVDF. Three reasons why PVDF is preferable are as follows.

PVDF has superior adhesiveness. Thus, peeling off of the first thin film 6B from the surface of the main body layer 6A or the surface of the second thin film 6C, and peeling off of the second thin film 6C from a surface of the first thin film 6B or the surface of the negative electrode 5 can be prevented during the process of forming the electrode group 8.

Moreover, PVDF has superior flexibility. Thus, each of the first thin film 6B and the second thin film 6C deforms along with the expansion or contraction of a negative electrode active material. Thus, the nonaqueous electrolyte secondary battery can be charged/discharged without degrading performance and safety, and it is possible to prevent the deterioration of cycle characteristics. This is more effective when metal or a metal-containing compound is used as the negative electrode active material. This is because when the negative electrode active material is metal or a metal-containing compound, the amount of expansion and the amount of deformation of the negative electrode active material due to charge/discharge increase compared to the case where the negative electrode active material is a carbon material, which increases the amount of deformation of the first thin film 6B and the second thin film 6C due to the expansion and contraction of the negative electrode active material.

PVDF is electrically stable in a voltage range within which the nonaqueous electrolyte secondary battery operates, and PVDF does not react with the nonaqueous electrolyte.

As described above, the first thin film 6B preferably contains PVDF and 2 mass to 30 mass %, both inclusive, of HFP, and may be made of, for example, a copolymer of VDF and 2 mass % to 30 mass %, both inclusive, of HFP. When the first thin film 6B is made of the copolymer as described above, the flexibility of VDF can be increased. Thus, the first thin film 6B is preferably made of a copolymer of VDF and 2 mass % to 30 mass %, both inclusive, of HFP.

The second thin film 6C preferably contains PVDF and 0 mass % to 20 mass %, both inclusive, of HFP, and may be made of a copolymer of, for example, VDF and 20 mass % or less of HFP, where 0 mass % is excluded, or may be made of PVDF. When the second thin film 6C is made of the above copolymer, the flexibility of VDF can be increased. Thus, the second thin film 6C is preferably made of a copolymer of VDF and 20 mass % or less of HFP, where 0 mass % is excluded.

The second thin film 6C will further be described. The second thin film 6C contains a smaller amount of HFP than the first thin film 6B, and thus contains a larger amount of an adhesive material than the first thin film 6B. Thus, the second thin film 6C is superior to the first thin film 6B in adhesiveness, so that the first thin film 6B can be adhered to the surface of the negative electrode 5 via the second thin film 6C. As described above, the second thin film 6C has the function of adhering the first thin film 6B to the negative electrode 5 in addition to the function of reducing the diffusion of metallic foreign particle ions compared to the first thin film 6B.

As described above, in the present embodiment, the separator 6 includes the first thin film 6B and the second thin film 6C. Thus, metallic foreign particle ions are diffused in the first thin film 6B or the second thin film 6C, so that it is possible to prevent the metallic foreign particle ions from arriving at the surface of the negative electrode 5. Moreover, even when the metallic foreign particle ions arrive at the surface of the negative electrode 5, metallic foreign particles are deposited in a direction substantially parallel to the surface of the negative electrode 5. Thus, the metallic foreign particles can be prevented from being deposited on one part of the negative electrode 5 in a concentrated manner, which can prevent an internal short-circuit caused by the entry of the metallic foreign particles, so that a nonaqueous electrolyte secondary battery with superior safety can be provided.

Moreover, in the present embodiment, the main body layer 6A, the first thin film 6B, and the second thin film 6C are sequentially arranged from the positive electrode 4 toward the negative electrode 5. Thus, metallic foreign particle ions penetrated through the film having the highest ionic permeability ratio (main body layer 6A) can be diffused in the film having an intermediate ionic permeability ratio (first thin film 6B). Moreover, metallic foreign particle ions penetrated through the film having an ionic permeability ratio of intermediate level (first thin film 6B) can be diffused in a film having the lowest ionic permeability ratio (second thin film 6C). Thus, the metallic foreign particle ions can efficiently be diffused in the first thin film 6B or the second thin film 6C.

In the present embodiment, the first thin film 6B is adhered to the surface of the negative electrode 5 via the second thin film 6C, and is integrated into the main body layer 6A. Thus, it is possible to satisfactorily provide the advantage that the ionic permeability ratio stepwise decreases from the positive electrode 4 toward the negative electrode 5. Moreover, it is possible to prevent a decrease in production yield of the electrode group 8.

In the present embodiment, each of the first thin film 6B and the second thin film 6C deforms along with the expansion or contraction of the negative electrode active material. Thus, degradation in performance and safety during charging/discharging can be prevented, and it is possible to prevent the deterioration of cycle characteristics.

In the present embodiment, the total thickness of the first thin film 6B and the second thin film 6C is much smaller than the thickness of the main body layer 6A. Thus, in the present embodiment, the diffusion of lithium ions is ensured, so that the performance of the battery can be ensured.

Significant advantages can be obtained by using the separator 6 of the present embodiment when lithium is added to the negative electrode before forming the electrode group. This will be specifically described below.

A nonaqueous electrolyte secondary battery is generally disadvantageous in that the capacity of the first discharge is lower relative to the capacity of the first charge (irreversible capacity is high). This is because an irreversible reaction such as film formation in a carbon material, or in metal or a metal-containing compound serving as a negative electrode active material occurs during the first charge. To solve this problem, the technique of adding lithium to a negative electrode before forming an electrode group has been proposed (e.g., Japanese Patent Publication No. 2005-085633).

However, when the above technique is used to fabricate a nonaqueous electrolyte secondary battery, a potential difference is exhibited between a positive electrode and a negative electrode immediately after injection of a nonaqueous electrolyte in a battery case. Thus, immediately after the injection of the nonaqueous electrolyte in the battery case, metallic foreign particles in the positive electrode are dissolved in the nonaqueous electrolyte, and are deposited on a surface of the negative electrode. Therefore, an internal short-circuit is likely to be caused by the entry of the metallic foreign particles compared to the case where a nonaqueous electrolyte secondary battery is fabricated without using the above technique. For example, an internal short-circuit is formed even when the amount of the metallic foreign particles entering the positive electrode is small.

However, when the separator 6 of the present embodiment is used, metallic foreign particles in the positive electrode 4 are dissolved in the nonaqueous electrolyte, and then are diffused in the first thin film 6B or the second thin film 6C, so that it is possible to prevent the metallic foreign particles in the positive electrode 4 from being deposited on the surface of the negative electrode 5. Thus, in the present embodiment, even when the dissolution of the metallic foreign particles starts immediately after injection of the nonaqueous electrolyte in the battery case, it is possible to prevent an internal short-circuit caused by the entry of the metallic foreign particles.

To overcome the disadvantage that the irreversible capacity is large, x/y>1.05 may be satisfied for the nonaqueous electrolyte secondary battery. Here, x is the total number of moles of lithium contained in the positive electrode and the negative electrode, y is the total number of moles of first metal (which is, for example, Co when the positive electrode active material is LiCoO₂) in the positive electrode active material, and x and y can be obtained by, for example, an inductively coupled plasma (ICP) analysis. In the positive electrode active material, the ratio of the number of moles between lithium and the first metal is generally 1:1 to 1:1.02. Thus, when x/y>1.05 is satisfied, it is understood that lithium is added to the negative electrode before forming the electrode group.

When x/y is larger, the disadvantage that the irreversible capacity is high is further reduced. However, when x/y is too large, the amount of lithium remaining in the negative electrode 5 (lithium irrelevant of charge/discharge) is large, which may reduce the heat stability of the negative electrode 5. Moreover, when lithium enters the negative electrode active material, the negative electrode active material expands, which causes expansion of the negative electrode 5. When the negative electrode 5 is in an expanded state, inserting and extracting capability of the nonaqueous electrolyte is reduced, which may deteriorate the cycle characteristics. In view of the foregoing, 1.05<x/y≦1.50 is preferable, and 1.05<x/y≦1.25 is more preferable.

To add lithium to the negative electrode before forming the electrode group, lithium may be vapor deposited on a surface of the negative electrode active material layer 5B, or lithium may be brought into contact with part of the negative electrode current collector 5A or the negative electrode active material layer 5B (for example, a lithium film is adhered to the surface of the negative electrode active material layer 5B, or a lithium film is welded to a part of the negative electrode current collector in which the negative electrode active material layer is not formed).

Recently, there has been a demand to increase the capacity of a nonaqueous electrolyte secondary battery. To fill the demand, it has been proposed that as the negative electrode active material, metal or a metal-containing compound is used instead of a carbon material. However, when the negative electrode active material is metal or a metal-containing compound, the irreversible capacity is large compared to the case where the negative electrode active material is a carbon material. Thus, when lithium is added to a negative electrode before forming an electrode group, and the negative electrode active material is metal or a metal-containing compound, the advantage of preventing an internal short-circuit caused by the entry of metallic foreign particles is significant.

Note that the present embodiment may have the following configuration.

The arrangement of the main body layer 6A, the first thin film 6B, and the second thin film 6C of the separator 6 is not limited to that illustrated in FIG. 3. The main body layer 6A, the first thin film 6B, and the second thin film 6C may be arranged as described below. A first arrangement is such that the first thin film 6B is provided on the surface of the positive electrode 4, the second thin film 6C is provided on the surface of the negative electrode 5, and the main body layer 6A is sandwiched between the first thin film 6B and the second thin film 6C. However, with this arrangement, it is not possible to stepwise reduce the ionic permeability ratio from the positive electrode 4 toward the negative electrode 5. For this reason, it may not be possible to efficiently diffuse metallic foreign particle ions in the first thin film 6B or the second thin film 6C.

A second arrangement is such that positions of the first thin film 6B and the second thin film 6C in the arrangement of FIG. 3 are exchanged. A third arrangement is such that positions of the first thin film 6B and the second thin film 6C in the first arrangement are exchanged. However, in the second and third arrangements, the first thin film 6B is provided directly on the surface of the negative electrode 5 without the second thin film 6C provided between the first thin film 6B and the surface of the negative electrode 5. Thus, it may not be possible to ensure the adhesive strength between the first thin film 6B and the negative electrode 5.

A fourth arrangement is such that the main body layer 6A is provided on the surface of the negative electrode 5, the first thin film 6B is provided on the surface of the positive electrode 4, and the second thin film 6C is sandwiched between the main body layer 6A and the first thin film 6B. A fifth arrangement is such that positions of the first thin film 6B and the second thin film 6C in the fourth arrangement are exchanged. However, in the fourth and fifth arrangements, the surface of the negative electrode 5 is provided without the first thin film 6B or the second thin film 6C, but provided with the main body layer 6A. Thus, metallic foreign particle ions may be deposited on the surface of the negative electrode 5, and metallic foreign particles deposited on the surface of the negative electrode 5 may reach the positive electrode 4 as illustrated in FIG. 1C.

For these reasons, the arrangement of FIG. 3 is preferred to the first to fifth arrangements. However, in the first to fifth arrangements, an internal short-circuit caused by the entry of metallic foreign particles can be prevented compared to the case where the separator is provided without the first thin film or the second thin film. Thus, a certain amount of the advantages of the present embodiment can be obtained also in the first to fifth arrangements.

The separator 6 preferably includes the first thin film 6B and the second thin film 6C. If the separator does not include the second thin film 6C, metallic foreign particle ions may arrive at the surface of the negative electrode 5, so that it may not be possible to prevent an internal short-circuit caused by the entry of metallic foreign particles. Moreover, it is difficult to adhere the first thin film 6B to the negative electrode 5, or the like, so that the production yield of the electrode group 8 may be reduced, and the first thin film 6B may be peeled off from the negative electrode 5, or the like due to the expansion and contraction of the negative electrode active material. If the separator 6 does not include the first thin film 6B, metallic foreign particle ions may not be satisfactorily diffused, so that metallic foreign particles may be deposited in one location in a concentrated manner, thereby causing defects leading to short circuits.

The separator 6 may include three or more thin films. In this case, three or more thin films are preferably arranged such that the ionic permeability ratio decreases from the positive electrode 4 toward the negative electrode 5 for the above reasons. However, when the number of thin films is too large, the occupancy of the thin films in the separator 6 is high, which may deteriorate the separator 6. Alternatively, when the number of thin films is increased without changing the total thickness of the thin films, the thickness of each thin film is very small, so that it is difficult to form each thin film. Taking these circumstances into consideration, the number of thin films may be determined. Note that when the number of thin films is increased without changing the total thickness of the thin films, an interface between the thin films may not be recognized.

When the separator 6 includes two thin films, the thickness of the first thin film 6B may be substantially the same as that of the second thin film 6C (for example, the thickness of the first thin film 6B is 40% to 60%, both inclusive, of the total thickness of the first thin film 6B and the second thin film 6C), may be much smaller than that of the second thin film 6C, or may be much larger than that of the second thin film 6C. In any case, the advantages of the present embodiment can be obtained. However, when the thickness of the first thin film 6B is substantially the same as that of the second thin film 6C, it is possible to obtain both the advantage obtained from the first thin film 6B, and the advantage obtained from the second thin film 6C in a balanced manner. Thus, it is preferable that the thickness of the first thin film 6B be substantially the same as that of the second thin film 6C.

The electrode group 8 may be formed by stacking the positive electrode 4 and the negative electrode 5 with the separator 6 interposed between the positive electrode 4 and the negative electrode 5.

The nonaqueous electrolyte secondary battery may include a positive electrode current collector plate instead of the positive electrode lead 4L, or a negative electrode current collector plate instead of the negative electrode lead 5L. Current collection by using the current collector plate can reduce resistance during the current collection compared to the case of current collection using the lead, so that it is possible to increase the power of the nonaqueous electrolyte secondary battery.

The nonaqueous electrolyte secondary battery may include a laminate film instead of the battery case 1. When the electrode group 8 is wrapped with the laminate film, the amount of metallic foreign particles from the metal case can be reduced compared to the case where the electrode group 8 is placed in the battery case 1 made of metal. This can contributes to the advantage that an internal short-circuit caused by the entry of metallic foreign particles can be prevented.

Configurations, materials, and methods for forming the positive electrode 4 and the negative electrode 5, respectively, a configuration of the main body layer 6A of the separator 6, materials of the nonaqueous electrolyte, and a method for fabricating the nonaqueous electrolyte secondary battery will be described below.

### Positive Electrode

The positive electrode current collector 4A may be made of aluminum, or may be made of a conductive material containing aluminum as a main material. The positive electrode current collector 4A may be a long conductor substrate or long foil, or may include a plurality of pores.

The thickness of the positive electrode current collector 4A is preferably 1 μm to 500 μm, both inclusive, more preferably 10 μm to 20 μm, both inclusive. With this configuration, the positive electrode 4 can be reduced in weight without reducing its strength.

The positive electrode active material is composite oxide containing lithium, first metal, and oxygen, and is, for example, LiCoO₂, LiNiO₂, LiMnO₂, LiCoNiO₂, LiCo_{1-z}M_{z}O₂, LiNi_{1-z}M_{z}O₂, LiNi_{1/3}Co_{1/3}Mn_{1/3}O₂, LiMn₂O₄, LiMnMO₄, LiMePO₄ or Li₂MePO₄F. M is at least one of Na, Mg, Sc, Y, Mn, Fe, Co, Ni, Cu, Zn, Al, Cr, Pb, Sb or B. Me is at least one selected from the group consisting of Fe, Mn, Co, and Ni. Z is greater than 0 and less than or equal to 1. As described above, the composite oxide includes a phosphate compound. In the positive electrode active material, some of the elements of the composite oxide may be substituted with other elements. Moreover, the positive electrode active material may be composite oxide surface-treated with metal oxide, lithium oxide, a conductive agent, or the like. The surface treatment is, for example, hydrophobization.

The positive electrode active material preferably has an average particle diameter of 5 μm to 20 μm, both inclusive. When the average particle diameter of the positive electrode active material is less than 5 μm, the surface area of particles of the active material is very large, which increases the amount of a binder required to fix the active material in an electrode plate. This reduces the amount of the positive electrode active material per electrode plate, so that the capacity may be reduced. By contrast, when the average particle diameter of the positive electrode active material is greater than 20 μm, streaks may appear on a surface of a slurry layer when positive electrode mixture slurry is applied to the positive electrode current collector 4A. Thus, the average particle diameter of the positive electrode active material is preferably 5 μm to 20 μm, both inclusive.

Examples of the binder include PVDF, polytetrafluoroethylene, polyethylene, polypropylene, an aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinyl pyrrolidone, polyether, polyethersulfone, hexafluoropolypropylene, styrene-butadiene-rubber, carboxymethylcellulose, etc. Alternatively, the binder is a copolymer or a mixture made of two or more materials selected from the group consisting of tetrafluoroethylene, hexafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene.

Among the listed materials, PVDF and a derivative thereof are chemically stable in the nonaqueous electrolyte secondary battery, are capable of sufficiently binding the positive electrode current collector 4A to the positive electrode active material or to the conductive agent, and in addition, are capable of sufficiently binding the positive electrode active material to the conductive agent. Thus, when PVDF or the derivative thereof is used as the binder, it is possible to provide a nonaqueous electrolyte secondary battery having superior cycle characteristics and discharge performance. In addition, PVDF and the derivative thereof are low-cost, and thus using PVDF or the derivative thereof as the binder can reduce the fabrication costs of the nonaqueous electrolyte secondary battery. For these reasons, it is preferable to use PVDF or the derivative thereof as the binder. Note that when PVDF is used as the binder, the positive electrode mixture slurry may be prepared using a solution obtained by dissolving PVDF in N-methyl pyrrolidone, or powder PVDF may be dissolved in the positive electrode mixture slurry.

The conductive agent may be, for example, graphites such as natural graphite and artificial graphite, carbon blacks such as acetylene black (AB) and ketjen black, conductive fibers such as carbon fiber and metal fiber, fluorocarbon, powders of metal such as aluminum, conductive whiskers such as zinc oxide and potassium titanate, conductive metal oxide such as titanium oxide, or an organic conductive material such as phenylene derivative.

A method for forming the positive electrode 4 will be described. First, the positive electrode active material, the binder, and the conductive agent are mixed with a liquid component, thereby preparing positive electrode mixture slurry. Here, the positive electrode mixture slurry may contain 3.0 vol. % to 6.0 vol. %, both inclusive, of the binder relative to the positive electrode active material. Next, the obtained positive electrode mixture slurry is applied to both the surfaces of the positive electrode current collector 4A, is dried, and then, the obtained positive electrode plate is rolled. Thus, a positive electrode having a predetermined thickness is formed.

### Negative Electrode

The negative electrode current collector 5A is preferably made of stainless steel, nickel, copper, or the like. The negative electrode current collector 5A may be a long conductor substrate or long foil, or may have a plurality of pores.

The thickness of the negative electrode current collector 5A is preferably 1 μm to 500 μm, both inclusive, more preferably 10 μm to 20 μm, both inclusive. With this configuration, the negative electrode 5 can be reduced in weight without reducing its strength.

Examples of the negative electrode active material include a carbon material, metal, metal fiber, oxide, nitride, a silicon compound, a tin compound, various types of alloy materials, etc. Examples of the carbon material include various types of natural graphite, coke, partially-graphitized carbon, carbon fiber, spherical carbon, various types of artificial graphite, and amorphous carbon. The silicon compound may be SiOₓ (where 0.05<x<1.95), may be a silicon alloy in which Si is partially substituted with at least one or more elements selected from the element group consisting of B, Mg, Ni, Ti, Mo, Co, Ca, Cr, Cu, Fe, Mn, Nb, Ta, V, W, Zn, C, N, and Sn, or may be a silicon solid solution. Moreover, the tin compound may be, for example, Ni₂Sn₄, Mg₂Sn, SnOₓ (where 0<x<2), SnO₂, or SnSiO₃. As the negative electrode active material, two of the above materials may be solely used, or two or more of the above materials may be combined.

The method for forming the negative electrode 5 will be described. When a carbon material is used as the negative electrode active material, the negative electrode active material (carbon material) and a binder are first mixed with a liquid component, thereby preparing negative electrode mixture slurry. Next, the obtained negative electrode mixture slurry is applied to both the surfaces of the negative electrode current collector 5A, is dried, and then, the obtained negative electrode plate is rolled. Thus, the negative electrode 5 having a predetermined thickness is formed.

When metal or a metal-containing compound is used as the negative electrode active material, the negative electrode active material may be vapor deposited on both the surfaces of the negative electrode current collector 5A.

The negative electrode 5 may be provided with lithium in advance to compensate the irreversible capacity.

### Separator

The separator 6 has the configuration described in the first embodiment. Note that the main body layer 6A may have the following configuration.

The main body layer 6A may be a material (a porous insulating film) obtained by binding insulative particles (e.g., metal oxide or metallic sulfide) to each other, may be a microporous thin film made of a polyolefin, or may include both woven fabric or nonwoven fabric and a porous insulating film. The insulative particles preferably have superior insulating properties and deformation resistance even at a high temperature. The porous insulating film is preferably fine powder of an insulator made of oxide such as aluminum oxide, magnesium oxide, or titanium oxide applied to an electrode plate. When the microporous thin film made of a polyolefin, woven fabric, or nonwoven fabric is used as the main body layer 6A, the main body layer 6A has a shut down function, so that it is possible to reduce a temperature rise of the nonaqueous electrolyte secondary battery. When the porous insulating film is used as the main body layer 6A, the contraction of the main body layer 6A can be prevented even when the temperature of the nonaqueous electrolyte secondary battery increases to a significantly high temperature (e.g., 200° C. or higer), so that it is possible to prevent an internal short-circuit. The configuration of the main body layer 6A may be selected based on, for example, applications of the nonaqueous electrolyte secondary battery.

When the microporous thin film is used as the main body layer 6A, the main body layer 6A may be a single-layer film made of one type of material, may be a composite film made of two or more types of materials, or may be a multilayer film obtained by stacking two or more layers made of materials different from each other.

The porosity of the main body layer 6A is preferably 30% to 70%, both inclusive, more preferably 35% to 60%, both inclusive. The porosity is the ratio of the volume of pores with respect to the total volume of the main body layer 6A.

### Nonaqueous Electrolyte

The nonaqueous electrolyte may be a liquid, gelled, or solid nonaqueous electrolyte.

In the liquid nonaqueous electrolyte (nonaqueous electrolyte, described later), an electrolyte (e.g., lithium salt) is dissolved in a nonaqueous solvent.

In the gelled nonaqueous electrolyte, a nonaqueous electrolyte is held in a polymer material. Examples of the polymer material include PVDF, polyacrylonitrile, polyethylene oxide, polyvinyl chloride, polyacrylate, and polyvinylidene fluoride hexafluoropropylene.

The solid nonaqueous electrolyte includes a solid polymer electrolyte.

The nonaqueous electrolyte will be described below.

As the nonaqueous solvent, a known nonaqueous solvent can be used, and for example, cyclic carbonic ester, chain carbonic ester, or cyclic carboxylate can be used. The cyclic carbonic ester is, for example, propylenecarbonate (PC) or ethylenecarbonate (EC). The chain carbonic ester is, for example, diethylcarbonate (DEC), ethylmethylcarbonate (EMC), or dimethylcarbonate (DMC). The cyclic carboxylate is, for example, γ-butyrolactone (GBL), or γ-valerolactone (GVL). As the nonaqueous solvent, one of the above nonaqueous solvents may be solely used, or two or more of the above nonaqueous solvents may be combined.

Examples of the electrolyte include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylate, LiCl, LiBr, LiI, chloroborane lithium, borates, and imidates. Examples of the borates include bis(1,2-benzene diolate (2-)-O,O′) lithium borate, bis(2,3-naphthalenediolate (2-)-O,O′) lithium borate, bis(2,2′-biphenyl diolate (2-)-O,O′) lithium borate, and bis(5-fluoro-2-olate-1-benzenesulfonic acid-O,O′) lithium borate. Examples of the imidates include lithium bistrifluoromethanesulfonimide ((CF₃SO₂)₂NLi), lithium trifluoromethanesulfonate nonafluorobutanesulfonimide (LiN(CF₃SO₂)(C₄F₉SO₂)), and lithium bispentafluoroethanesulfonimide ((C₂F₅SO₂)₂NLi). As the electrolyte, one of the above electrolytes may be solely used, or two or more of the above electrolytes may be combined.

The concentration of the electrolyte is preferably 0.5 mol/m³ to 2 mol/m³, both inclusive.

The nonaqueous electrolyte may include the following additive in addition to the nonaqueous solvent and the electrolyte. The additive is decomposed on the surface of the negative electrode active material layer, thereby forming a coat having high lithium ion conductivity on the surface of the negative electrode active material layer. This can increase the coulombic efficiency of the nonaqueous electrolyte secondary battery. Examples of the additive having such a function include vinylenecarbonate (VC), 4-methyl vinylene carbonate, 4,5-dimethyl vinylene carbonate, 4-ethyl vinylene carbonate, 4,5-diethyl vinylene carbonate, 4-propyl vinylene carbonate, 4,5-dipropyl vinylene carbonate, 4-phenylvinylene carbonate, 4,5-diphenylvinylene carbonate, vinyl ethylene carbonate (VEC), and divinylethylene carbonate. As the additive, one of the above materials may be solely used, or two or more of the above materials may be combined. As the additive, at least one selected from the group consisting of vinylene carbonate, vinylethylene carbonate, and divinylethylene carbonate is preferably used. Note that the additive may be made of the above materials in which some of hydrogen atoms are substituted with fluorine atoms.

Moreover, the nonaqueous electrolyte may include a benzene derivative in addition to the nonaqueous solvent and the electrolyte. The benzene derivative preferably includes a phenyl group, or preferably includes a phenyl group and a cyclic compound group which are bonded at positions adjacent to each other. Here, examples of the benzene derivative include cyclohexylbenzene, biphenyl, and diphenyl ether. Moreover, examples of the cyclic compound group include a phenyl group, a cyclic ether group, a cyclic ester group, a cycloalkyl group, and phenoxy group. As the benzene derivative, one of the above materials may be solely used, or two or more of the above materials may be combined. Note that the nonaqueous solvent may contain less than or equal to 10 vol. % of benzene derivative. When the nonaqueous electrolyte contains such amount of benzene derivative, the benzene derivative is decomposed in the case of overcharge, thereby forming a coat on a surface of the electrode, which can cause the nonaqueous electrolyte secondary battery to be inactive.

A method for fabricating a nonaqueous electrolyte secondary battery will be described. First, the positive electrode lead 4L is connected to a part of the positive electrode current collector 4A in which the positive electrode mixture layer 4B is not provided, and the negative electrode lead 5L is connected to a part of the negative electrode current collector 5A in which the negative electrode active material layer 5B is not provided. Next, the positive electrode 4 and the negative electrode 5 are wound with the separator 6 interposed therebetween, thereby forming the electrode group 8. Here, it is ensured that the positive electrode lead 4L and the negative electrode lead 5L extend in directions opposite to each other. Subsequently, the upper insulating plate 7a is disposed at un upper end of electrode group 8, and the lower insulating plate 7b is disposed at a lower end of the electrode group 8. Then, the negative electrode lead 5L is connected to the battery case 1, and the positive electrode lead 4L is connected to the sealing plate 2, thereby placing the electrode group 8 in the battery case 1. After that, the nonaqueous electrolyte is injected into the battery case 1 by a decompression process. Then, the opening la of the battery case 1 is sealed with the sealing plate 2 via the gasket 3.

### EXAMPLES

Examples of the present invention will be described below. Note that the present invention is not limited to the following examples.

### First Example

### 1. Method for Fabricating Nonaqueous Electrolyte Secondary Battery

### Battery 1

### Formation of Positive Electrode

First, LiNi_{0.82}Co_{0.15}Al_{0.03}O₂ (positive electrode active material) having an average particle diameter of 10 μm was prepared.

Next, 4.5 parts by mass of acetylene black (conductive agent) and a solution obtained by dissolving 4.7 parts by mass of PVDF (binder) in an N-methyl pyrrolidone (NMP, NMP is abbreviation for N-methylpyrrolidone) solvent were mixed with 100 parts by mass of LiNi_{0.82}Co_{0.15}Al_{0.03}O₂, thereby obtaining positive electrode mixture slurry.

The positive electrode mixture slurry was applied to both surfaces of aluminum foil (positive electrode current collector) having a thickness of 15 was dried, and then, the obtained electrode plate was rolled. Thus, a positive electrode plate having a thickness of 0.157 mm was obtained. The positive electrode plate was cut to a width of 57 mm and a length of 564 mm, thereby obtaining a positive electrode.

### Formation of Negative Electrode

First, silicon was vapor deposited by vacuum evaporation on both roughened surfaces of copper foil (negative electrode current collector) having a thickness of 18 μm. Here, the degree of vacuum in a vacuum evaporation system was controlled to 1.5×10⁻³ Pa while 25 sccm of oxygen was injected in the vacuum evaporation system. Thus, a silicon-containing film having a thickness of 10 μm was formed on each surface of the copper foil. Measurement of an oxygen amount by a combustion method and measurement of a silicon amount by an ICP analysis showed that the composition of an active material contained in the silicon-containing film was SiO_{0.42}.

Next, lithium was vapor deposited by vacuum evaporation on each surface of the silicon-containing films. Thus, a lithium film having a density of 3.2 g/m² (a lithium film having a thickness of 6 μm when the density of lithium was converted at the thickness of the lithium film) was formed on each surface of the silicon-containing films. After that, the obtained negative electrode plate was handled in dry air atmosphere at a dew point temperature of −30° C. or lower.

Subsequently, an N-methyl-2-pyrrolidone solution (concentration: 8 mass %) containing a polymer obtained by copolymerizing VDF and HFP in such a ratio that VDF:HFP=97:3 (by mass) was applied to one surface of the negative electrode plate, and was dried. Thus, a polymer layer (a second thin film, hereinafter referred to as a “negative-electrode-side polymer layer”) having a thickness of 1 μm was formed. Thereafter, a dimethyl carbonate solution (concentration: 5 mass %) containing a polymer obtained by copolymerizing VDF and HFP in such a ratio that VDF:HFP=88:12 (by mass) was applied to the negative-electrode-side polymer layer, and was dried. Thus, a polymer layer (a first thin film, hereinafter referred to as a “main-body-layer-side polymer layer”) having a thickness of 1 μm was formed. After that, the negative electrode plate provided with these two polymer layers was cut to a width of 58.5 mm and a length of 750 mm, thereby obtaining the negative electrode.

### Preparation of Nonaqueous Electrolyte

A mixed solvent was prepared by mixing ethylene carbonate and dimethyl carbonate in a volume ratio of 1:3. To the mixed solvent, 5 weight percent (wt. %) of vinylene carbonate (additive for improving the coulombic efficiency of the battery) was added, and LiPF₆ (electrolyte) was dissolved in the mixed solvent at a mole concentration of 1.4 mol/m³ (relative to the mixed solvent). In this way, a nonaqueous electrolyte was obtained.

### Fabrication of Cylindrical Battery

First, a positive electrode lead made of aluminum was connected to the positive electrode current collector, and a negative electrode lead made of nickel was connected to the negative electrode current collector. Thereafter, the positive electrode and the negative electrode were disposed so that the positive electrode lead and the negative electrode lead extended in directions opposite to each other, and the positive electrode, the negative electrode, and a polyethylene film (a main body layer, having a thickness of 20 μm) were wound with the polyethylene film sandwiched between the positive electrode and the main-body-layer-side polymer layer. In this way, an electrode group was formed. An ICP analysis showed that the total number of moles of lithium contained in the positive electrode and the negative electrode of the electrode group was 1.13 when the total number of moles of Ni, Co, and Al contained in the positive electrode was 1.

Next, an upper insulating film was disposed at an upper end of the electrode group, and a lower insulating plate was disposed at a lower end of the electrode group. After that, the negative electrode lead was welded to a battery case, and the positive electrode lead was welded to a sealing plate, thereby placing the electrode group in the battery case. Thereafter, the nonaqueous electrolyte was injected in the battery case by a decompression process. Then, the sealing plate was crimped onto an opening end of the battery case via a gasket. Thus, Battery 1 was fabricated.

### Battery 2

Battery 2 was fabricated in the same manner as Battery 1 except for the configuration of the main-body-layer-side polymer layer. Specifically, a dimethyl carbonate solution (concentration: 5 mass %) containing a polymer obtained by copolymerizing VDF and HFP in such a ratio that VDF:HFP=85:15 (by mass) was applied to the negative-electrode-side polymer layer, and was dried.

### Battery 3

Battery 3 was fabricated in the same manner as Battery 1 except that the negative-electrode-side polymer layer had a thickness of 3 μm, and the main-body-layer-side polymer layer had a thickness of 5 μm.

### Battery 4

Battery 4 was fabricated in the same manner as Battery 1 except that the negative-electrode-side polymer layer was made of a PVDF film. Specifically, an N-methyl-2-pyrrolidone solution (concentration: 12 mass %) containing only PVDF was applied to one surface of the negative electrode plate, and was dried.

### Battery 5

Battery 5 was fabricated in the same manner as Battery 1 except that the polymer layer was not formed on the surface of the negative electrode plate.

### Battery 6

Battery 6 was fabricated in the same manner as Battery 1 except that only one polymer layer was formed on one surface of the negative electrode plate. Specifically, an N-methyl-2-pyrrolidone solution (concentration: 12 mass %) containing only PVDF was applied to one surface of the negative electrode plate, and wad dried. After that, the negative electrode plate was cut to obtain a negative electrode.

### Battery 7

Battery 7 was fabricated in the same manner as Battery 1 except that only one polymer layer was formed on one surface of the negative electrode. Specifically, a dimethyl carbonate solution (concentration: 5 mass %) containing a polymer obtained by copolymerizing VDF and HFP in such a ratio that VDF:HFP=88:12 (by mass) was applied to one surface of the negative electrode plate, and was dried. After that, the negative electrode plate was cut to obtain a negative electrode.

### 2. Evaluation

The voltage of a battery having an internal short-circuit is lower than that of a battery having no internal short-circuit. The voltage of each battery of the first example is about 2.8 V. Thus, in the first example, the battery whose measured voltage was lower than 2.6 V was regarded as being failed, and the number of failed batteries (in 50 batteries) was counted.

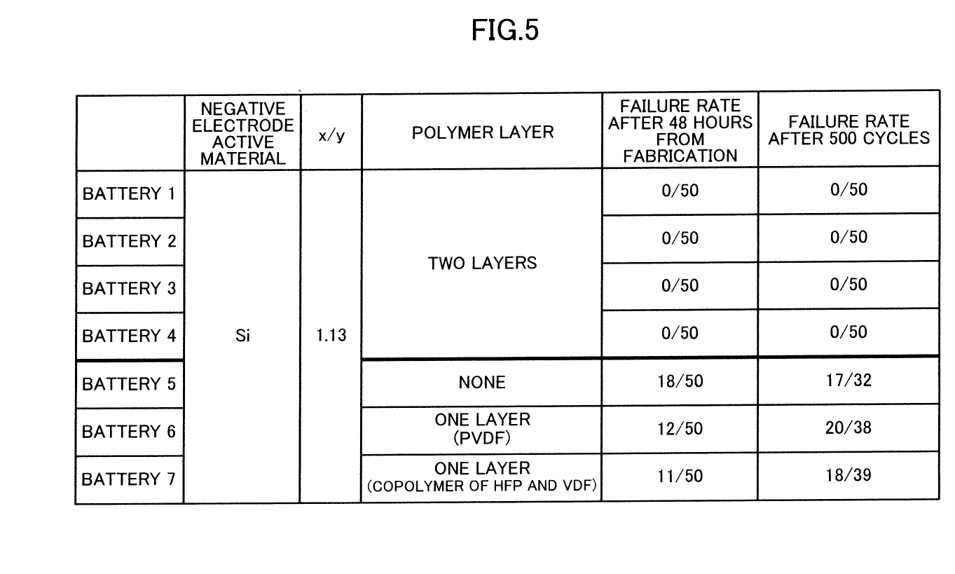

Specifically, after 48 hours from the fabrication of Batteries 1-7. their voltages were measured, and the number of batteries having internal short-circuits was counted. The results are shown in the failure rate after 48 hours from the fabrication in FIG. 5. Moreover, each of Batteries 1-7 was subjected to 500 cycles of charge/discharge, and its voltage was measured. Then, the number of batteries having internal short-circuits was counted. One cycle includes a series of operation in which the battery is charged at a constant current of 1.4 A at 45° C. until the voltage reaches 4.15 V, is charged at a constant voltage of 4.15 V until the current reaches 50 mA, and then is discharged at a constant current of 2.8 A until the voltage reaches 2.0 V. Note that a 30-minute pause was taken between charge and discharge, and between discharge and charge. The results are shown in the failure rate after 500 cycles in FIG. 5.

### Second Example

In a second example, a negative-electrode-side polymer layer and a main-body-layer-side polymer layer were fixed on one surface of a polyethylene film, thereby forming a separator.

### 1. Method for Fabricating Nonaqueous Electrolyte Secondary Battery

### Battery 8

Battery 8 was fabricated in the same manner as the Battery 1 except for the configurations of the negative-electrode-side polymer layer and the main-body-layer-side polymer layer, the method for forming the negative electrode, and the method for forming the negative-electrode-side polymer layer and the main-body-layer-side polymer layer.

### Formation of Negative Electrode

Specifically, lithium was vapor deposited by vacuum evaporation on a surface of a silicon-containing film according to “-Formation of Negative Electrode-” of Battery 1, and then the obtained electrode plate was cut to a width of 58.5 mm and a length of 750 mm. Thus, a negative electrode was obtained.

### Formation of Separator

A polyethylene film (thickness: 20 μm) was immersed in N-methyl-2-pyrrolidone. After that, an N-methyl-2-pyrrolidone solution (concentration: 3 mass %) containing a polymer obtained by copolymerizing VDF and HFP in such a ratio that VDF:HFP=95:5 (by mass) was applied to one surface of the polyethylene film, and was dried together with the polyethylene film. In this way, a main-body-layer-side polymer was formed on the one surface of the polyethylene film. Note that the total thickness of the polyethylene film and the main-body-layer-side polymer was 21 μm.

Subsequently, an N-methyl-2-pyrrolidone solution (concentration: 12 mass %) containing only PVDF was applied to the main-body-layer-side polymer layer, and was dried. The thickness after drying was 22 μm.

### Battery 9

Battery 9 was fabricated in the same manner as Battery 8 except for the configurations of the negative-electrode-side polymer layer and the main-body-layer-side polymer layer.

Specifically, a dimethyl carbonate solution (concentration: 5 mass %) containing a polymer obtained by copolymerizing VDF and HFP in such a ratio that VDF:HFP=88:12 (by mass) was applied to one surface of a polyethylene film, and was dried. The thickness after drying was 20 μm. The cross section of the polyethylene film after drying was checked, and it was found that the one surface of the polyethylene film was impregnated with the polymer.

Next, an N-methyl-2-pyrrolidone solution (concentration: 3 mass %) containing a polymer obtained by copolymerizing VDF and HFP in such a ratio that VDF:HFP=95:5 (by mass) was applied to a surface of the main-body-layer-side polymer layer, and was dried.

The average thickness after drying was 21 μm.

### Battery 10

Battery 10 was fabricated in the same manner as Battery 8 except that only the main-body-layer-side polymer layer was formed on one surface of the polyethylene film.

### 2. Evaluation

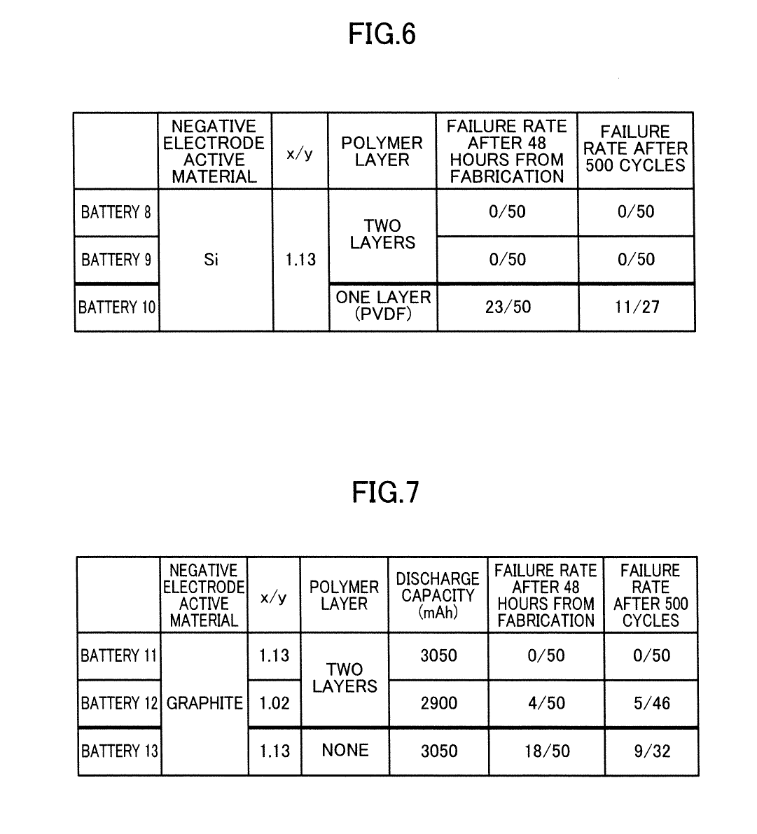

Batteries 8-10 were evaluated in the same manner as the evaluation in the first example. The results of the evaluation are shown in FIG. 6.

### Third Example

In a third example, graphite was used as a negative electrode active material.

### 1. Method for Fabricating Nonaqueous Electrolyte Secondary Battery

### Battery 11

Battery 11 was fabricated in the same manner as Battery 2 except that graphite was used as the negative electrode active material.

### Formation of Negative Electrode

First, flake artificial graphite (negative electrode active material) was pulverized and classified to have an average particle diameter of about 20 μm.

Next, 3 parts by mass of styrene-butadiene-rubber (binder) and 100 parts by mass of an aqueous solution containing 1 mass % carboxymethylcellulose were added to 100 parts by mass of the flake artificial graphite, and were mixed. Thus, negative electrode mixture slurry was obtained.

Subsequently, the negative electrode mixture slurry was applied to both surfaces of copper foil (negative electrode current collector) having a thickness of 8 μm, and was dried. The obtained electrode plate was rolled. Thus, a negative electrode plate having a thickness of 0.156 mm was obtained. The negative electrode plate was subjected to thermal treatment with hot air at 190° C. for 8 hours in a nitrogen atmosphere. The negative electrode plate after the thermal treatment was cut to obtain a negative electrode having a thickness of 0.156 mm, a width of 58.5 mm, and a length of 750 mm. Note that the negative electrode active material provided on a portion of the negative electrode plate which did not face a positive electrode active material when an electrode group was formed (end portion in the longitudinal direction of the negative electrode) was removed.

Then, an N-methyl-2-pyrrolidone solution (concentration: 8 mass %) containing a polymer obtained by copolymerizing VDF and HFP in such a ratio that VDF:HFP=97:3 (by mass) was applied to a surface of the negative electrode, and was dried. Thus, a negative-electrode-side polymer layer having a thickness of 1 μm was formed. Thereafter, a dimethyl carbonate solution (concentration: 5 mass %) containing a polymer obtained by copolymerizing VDF and HFP in such a ratio that VDF:HFP=85:15 (by mass) was applied to a surface of the negative-electrode-side polymer layer, and was dried. Thus, a main-body-layer-side polymer layer having a thickness of 1 μm was formed.

Then, a lithium film having a thickness of 100 μm, a width of 50 mm, and a length of 50 mm was attached to an end portion (portion at which the copper foil was exposed) in the longitudinal direction of the negative electrode.

### Battery 12

Battery 12 was fabricated in the same manner as Battery 11 except that the negative electrode was formed without attaching the lithium film to the copper foil.

### Battery 13

Battery 13 was fabricated in the same manner as Battery 11 except that the polymer layer was not formed on the surface of the negative electrode plate.

### 2. Evaluation

Batteries 11-13 were evaluated in the same manner as the evaluation in the first example. Here, in the present example, it was provided that in the charge/discharge cycle, the charge end voltage was 4.2 V, and the discharge end voltage was 2.5 V. The results of evaluation are shown in FIG. 7.

Moreover, in the present example, the capacity of each battery was measured. The capacity of each battery was a capacity obtained when the battery was charged at a constant current of 1.4 A at 25° C. until the voltage reached 4.2 V, was charged at a constant voltage of 4.2 V until the current reached 50 mA, and then was discharged at a constant current of 0.56 A until the voltage reached 2.5 V.

### Discussion

The results of the first to third examples will be discussed based on FIGS. 5-7.

### First Example

In Batteries 1-4, the failure rate after 48 hours from the fabrication and the failure rate after 500 cycles were both 0. When these batteries were disassembled, and cross sections of the negative electrode, the negative-electrode-side polymer layer, and the main-body-layer-side polymer layer were checked, deposited substances made of a metallic element such as Fe, Ni, or the like were observed in part of the cross sections. However, these deposited substances did not go beyond the separator, and did not reach the positive electrode, but were formed along the surface of the negative electrode.

By contrast, of Batteries 5-7, batteries having internal short-circuits were likewise analyzed, and needle-like deposition of metallic elements such as Fe, Ni, or the like was found. These deposited substances broke through the separator, and reached the positive electrode.

In each of Batteries 1-4 and Batteries 5-7, the total number of moles of metal in the polyethylene film, the negative-electrode-side polymer layer, the main-body-layer-side polymer layer, and the electrolyte was measured by an ICP analysis. Batteries 1-7 had substantially the same total number of moles of metal. That is, the amount of dissolved metallic foreign particles was the same in Batteries 1-4 and in Batteries 5-7. However, since Batteries 1-4 were different from Batteries 5-7 in deposition form of metallic foreign particles, no internal short-circuit occurred in Batteries 1-4 whereas internal short-circuits occurred in Batteries 5-7.

### Second Example

Results similar to the first example was obtained.

### Third Example

The discharge capacity of Battery 12 was smaller than each of the discharge capacities of Battery 11 and Battery 13. This is probably because the irreversible capacity of the negative electrode is not compensated.

Since in Battery 13, the negative-electrode-side polymer layer and the main-body-layer-side polymer layer were not formed, needle-like deposited substances penetrated through the separator, and reached the positive electrode in the same manner as the Batteries 5-7 and Battery 10. As a result, an internal short-circuit occurred.

### INDUSTRIAL APPLICABILITY

As described above, the present invention is applicable to, for example, power supplies of consumer electronics, power supplies in vehicles, or power supplies of large-scaled tools.

### DESCRIPTION OF REFERENCE CHARACTERS

1 Battery Case

2 Sealing Plate

3 Gasket

4 Positive Electrode

4A Positive Electrode Current Collector

4B Positive Electrode Mixture Layer

5 Negative Electrode

5A Negative Electrode Current Collector

5B Negative Electrode Active Material Layer

6 Separator

6A Main Body Layer

6B First Thin Film

6C Second Thin Film

7a Upper Insulating Plate

7b Lower Insulating Plate

8 Electrode Group

1. A nonaqueous electrolyte secondary battery comprising:
a positive electrode;
a negative electrode;
a separator disposed between the positive electrode and the negative electrode; and
a nonaqueous electrolyte,
the positive electrode, the negative electrode, the separator, and the nonaqueous electrolyte being placed in a battery case, wherein
the separator includes a main body layer and a plurality of thin films,
each of the thin films has a smaller thickness than the main body layer, and a lower ionic permeability ratio than the main body layer, and
the thin films have ionic permeability ratios different from each other.

2. The nonaqueous electrolyte secondary battery of claim 1, wherein
a thin film which is the lowest in ionic permeability ratio among the plurality of thin films is provided on a surface of the negative electrode.

3. The nonaqueous electrolyte secondary battery of claim 2, wherein
the thin film which is the lowest in ionic permeability ratio among the plurality of thin films is adhered to the surface of the negative electrode.

4. The nonaqueous electrolyte secondary battery of claim 1, wherein
the plurality of thin films are arranged such that the ionic permeability ratio of the thin films decreases from the positive electrode toward the negative electrode.

5. The nonaqueous electrolyte secondary battery of claim 4, wherein
the main body layer is provided on a surface of the positive electrode, and
a thin film which is the highest in ionic permeability ratio among the plurality of thin films is integrated into the main body layer.

6. The nonaqueous electrolyte secondary battery of claim 1, wherein
the plurality of thin films have hexafluoropropylene concentrations different from each other, and
the thin film having a low hexafluoropropylene concentration has a lower ionic permeability ratio than the thin film having a high hexafluoropropylene concentration.

7. The nonaqueous electrolyte secondary battery of claim 6, wherein
each of the plurality of thin films contains a copolymer of hexafluoropropylene and vinylidene fluoride.

8. The nonaqueous electrolyte secondary battery of claim 6, wherein
a thin film which is the lowest in ionic permeability ratio among the plurality of thin films contains no hexafluoropropylene, and is made of polyvinylidene fluoride.

9. The nonaqueous electrolyte secondary battery of claim 1, wherein
the positive electrode includes composite oxide containing lithium, first metal which is metal except for the lithium, and oxygen, and
x/y is greater than 1.05, where a total number of moles of lithium contained in the positive electrode and the negative electrode is x[mol], and a total number of moles of the first metal in the composite oxide is y[mol].

10. The nonaqueous electrolyte secondary battery of claim 9, wherein the negative electrode includes silicon, tin, or a compound containing silicon or tin.
